(19) United States
(12) Patent Application Publication
(10) Pub. No.: US 2025/0287035 A1
(43) Pub. Date: Sep. 11, 2025

(54) MOTION VECTOR MAGNITUDE RESTRICTION AND HOLE FILLING FOR TEMPORALLY INTERPOLATED PICTURE FRAME PREDICTION

(71) Applicant: GOOGLE LLC, Mountain View, CA (US)

(72) Inventors: Janne Salonen, Oulu (FI); Stanislav Vitvitskyy, Mountain View, CA (US); In Suk Chong, Mountain View, CA (US)

(21) Appl. No.: 19/071,503

(22) Filed: Mar. 5, 2025

Related U.S. Application Data
(60) Provisional application No. 63/562,787, filed on Mar. 8, 2024.

(51) Int. Cl. H04N 19/55; H04N 19/513; H04N 19/577

(52) U.S. Cl. CPC H04N 19/55; H04N 19/521; H04N 19/577

(57) ABSTRACT

Hardware-friendly approaches to generated reference frame prediction include motion vector magnitude restriction and hole filling. Motion vector magnitude restriction generally refers to the restriction of motion vector for prediction with a generated reference frame to a same block or a set of blocks including the same block within a portion of the generated reference frame. Hole filling generally refers to the identification of available motion vectors for a portion of a generated reference frame and their use for other cells of that portion for which motion vectors are unavailable. The disclosed motion vector magnitude restriction and hole filling approaches enable effective generated reference frame prediction in a hardware coder use case by, in relevant part, preventing the use of a motion vector that points outside of a generated reference frame portion stored within a working buffer or cache and avoiding unbounded execution times otherwise arising from epoch-based hole filling approaches.

### CROSS-REFERENCE TO RELATED APPLICATION(S)

This application claims the benefit of U.S. Provisional Application Ser. No. 63/562,787, filed Mar. 8, 2024, the disclosure of which is herein incorporated by reference in its entirety.

### BACKGROUND

Digital video streams may represent video using a sequence of frames or still images. Digital video can be used for various applications including, for example, video conferencing, high definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including encoding or decoding techniques.

### SUMMARY

Disclosed herein are, inter alia, systems and techniques for motion vector magnitude restriction and hole filling for generated reference frame (e.g., temporally interpolated picture (TIP) frame) prediction.

A method for motion vector magnitude restriction for generated reference frame prediction according to an implementation of this disclosure comprises: identifying forward and backward reference frames for a current frame; determining a portion of a generated reference frame using the forward and backward reference frames; generating a prediction block by predicting a current block of the current frame according to a motion vector restricted to one of a same block located within the portion of the generated reference frame or a set of blocks including the same block and located within the portion of the generated reference frame, wherein a location of the same block within the portion of the generated reference frame corresponds to a location of the current block within the current frame; and decoding a prediction residual associated with the current block using the prediction block.

In some implementations of the method, the portion of the generated reference frame corresponds to an area of the current frame which includes the current block, one or more blocks which precede the current block in a scan order, and one or more blocks which follow the current block in the scan order.

In some implementations of the method, the area of the current frame is within a working buffer or cache of a hardware coder.

In some implementations of the method, the motion vector is restricted to the same block and an outline of a location to which the motion vector points resides completely within the same block.

In some implementations of the method, a fractional portion of the motion vector is omitted where the outline of the location resides within a threshold number of pixels of an edge of the same block.

In some implementations of the method, the motion vector is restricted to the set of blocks, the set of blocks includes multiple rows of blocks, and the same block is located in a bottom-most row of the multiple rows of blocks.

In some implementations of the method, one or more first blocks preceding the same block in a scan order are recently coded blocks and one or more second blocks following the same block in the scan order correspond to a lookahead window of a hardware coder.

In some implementations of the method, the generated reference frame is a temporally interpolated picture frame.

A non-transitory computer readable medium according to an implementation of this disclosure has stored thereon an encoded bitstream configured for decoding by operations for motion vector magnitude restriction for generated reference frame prediction, the operations comprising: determining a portion of a generated reference frame using forward and backward reference frames for a current frame; generating a prediction block by predicting a current block of the current frame according to a motion vector restricted to one of a same block located within the portion of the generated reference frame or a set of blocks including the same block and located within the portion of the generated reference frame; and decoding a prediction residual associated with the current block using the prediction block.

In some implementations of the non-transitory computer readable medium, a location of the same block within the portion of the generated reference frame corresponds to a location of the current block within the current frame.

In some implementations of the non-transitory computer readable medium, the motion vector is restricted to the same block and an outline of a location to which the motion vector points resides completely within the same block.

In some implementations of the non-transitory computer readable medium, a fractional portion of the motion vector is omitted where the outline of the location resides within a threshold number of pixels of an edge of the same block.

In some implementations of the non-transitory computer readable medium, the motion vector is restricted to the set of blocks, the set of blocks includes multiple rows of blocks, and the same block is located in a bottom-most row of the multiple rows of blocks.

In some implementations of the non-transitory computer readable medium, one or more first blocks preceding the same block in a scan order are recently coded blocks and one or more second blocks following the same block in the scan order correspond to a lookahead window of a hardware coder.

An apparatus for motion vector magnitude restriction for generated reference frame prediction according to an implementation of this disclosure comprises: a memory; and a processor configured to execute instructions stored in the memory to: generate a prediction block by predicting a current block of a current frame according to a motion vector restricted to one of a same block located within a portion of a generated reference frame or a set of blocks including the same block and located within the portion of the generated reference frame, wherein a location of the same block within the portion of the generated reference frame corresponds to a location of the current block within the current frame; and decode a prediction residual associated with the current block using the prediction block.

In some implementations of the apparatus, the portion of the generated reference frame is determined using forward and backward reference frames for the current frame.

In some implementations of the apparatus, the motion vector is restricted to the same block and an outline of a location to which the motion vector points resides completely within the same block.

In some implementations of the apparatus, a fractional portion of the motion vector is omitted where the outline of the location resides within a threshold number of pixels of an edge of the same block.

In some implementations of the apparatus, the motion vector is restricted to the set of blocks, the set of blocks includes multiple rows of blocks, and the same block is located in a bottom-most row of the multiple rows of blocks.

In some implementations of the apparatus, one or more first blocks preceding the same block in a scan order are recently coded blocks and one or more second blocks following the same block in the scan order correspond to a lookahead window of a hardware coder.

These and other aspects of this disclosure are disclosed in the following detailed description of the implementations, the appended claims and the accompanying figures.

### BRIEF DESCRIPTION OF THE DRAWINGS

The description herein makes reference to the accompanying drawings described below, wherein like reference numerals refer to like parts throughout the several views.

FIG. 1 is a schematic of an example of a video encoding and decoding system.

FIG. 2 is a block diagram of an example of a computing device that can implement a transmitting station or a receiving station.

FIG. 3 is a diagram of an example of a video stream to be encoded and decoded.

FIG. 4 is a block diagram of an example of an encoder.

FIG. 5 is a block diagram of an example of a decoder.

FIG. 6 is an illustration of examples of portions of a video frame.

FIG. 7 is an illustration of frames used in connection with TIP frame prediction.

FIGS. 8A-C are illustrations of unrestricted and restricted motion vectors for TIP frame prediction.

FIGS. 9A-B are illustrations of motion vector hole filling for TIP frame prediction.

FIG. 10 is a flowchart diagram of an example of a technique for motion vector magnitude restriction for TIP frame prediction.

FIG. 11 is a flowchart diagram of an example of a technique for motion vector hole filling for TIP frame prediction during decoding.

### DETAILED DESCRIPTION

Video compression schemes may include breaking respective images, or frames, of a video stream into smaller portions, such as blocks, and generating an encoded bitstream by using encoding techniques to limit the information included for respective blocks thereof. The bitstream can be decoded to re-create the source frames from the limited information. A video stream can be compressed (i.e., encoded) by a variety of techniques to reduce the bandwidth required to transmit or store the video stream. Similarly, a variety of techniques can be used to decompress (i.e., decode) a compressed video stream from a bitstream, to prepare the video stream for viewing or further processing. Compression of the video stream often exploits spatial and temporal correlation of video signals through spatial and/or motion-compensated prediction. Motion-compensated prediction may also be referred to as inter-prediction. Inter-prediction uses one or more motion vectors to generate a block (also called a prediction block) that resembles a current block to be encoded using previously encoded and decoded pixels. By encoding the motion vector(s), and the difference between the two blocks (i.e., a residual), a decoder receiving the encoded signal can reconstruct the current block by generating the prediction block and adding pixels of the prediction block to the decoded residual block.

Each motion vector used to generate a prediction block in the inter-prediction process refers to a reference frame (i.e., a frame other than a current frame which includes the block that is under prediction). Reference frames can be located before or after the current frame in the sequence of the video stream and may be frames that are reconstructed before being used as a reference frame. In particular, a reference frame may be a forward reference frame (i.e., a frame used for forward prediction relative to the sequence) or a backward reference frame (i.e., a frame used for backward prediction relative to the sequence). One or more forward and/or backward reference frames can be used to encode or decode a block. In particular, because many conventional video compression and decompression schemes use a pyramid coding structure to achieve high compression efficiencies, many frames are encoded and decoded using bi-directional prediction, such as using a forward reference frame and a backward reference frame. Bi-directional prediction using forward and backward reference frames has been shown to substantially improve the quality of prediction and thus the overall compression performance for the subject video stream.

Some recent approaches for bi-directional prediction use a TIP frame, which is a reference frame generated by interpolating reference blocks from a forward reference frame and a backward reference frame (e.g., as the nearest past and future reference frames relative to the current frame). In particular, the coded motion vectors available in the forward and backward reference frames are used to generate a motion field for the current frame, and the motion field is then used to fetch the reference blocks which are used to generate the TIP frame. TIP frame prediction thus refers to an inter-prediction mode whereby a TIP frame is used to predict the motion of a current frame. The TIP frame is independently generated at each of the encoder and the decoder. In particular, the encoder generates the TIP frame using data determined as part of an encoder search process, and the decoder generates the TIP frame using bitstream data indicative of that encoder search process. The TIP frame can be generated in full before it is used or generated piece by piece in a streaming manner by which individual portions are generated using the motion field. The use of this TIP mode for video coding has shown remarkable coding gain achievements relative to video coding schemes which do not use the TIP mode.

With TIP frame prediction, blocks of a TIP frame are compound-predicted and motion vectors of the TIP frame are derived. In particular, and as described above, the derivation of motion vectors for the TIP frame is based on projections from the forward and backward reference frames, which, in at least some cases, are temporarily adjacent to the TIP frame. Assuming linear motion, an object moving some distance between those forward and backward reference frames will be understood to move a smaller but proportional distance between one of those reference frames and the TIP frame. However, given the contents of the forward and backward reference frames, it may sometimes be the case that one or more areas on the TIP frame may not coincide with any motion vectors from the backward reference frame to the forward reference frame and vice versa. To address these cases, typical TIP frame prediction approaches use a hole filling algorithm to determine motion vectors for those areas.

Generally, a hole filling algorithm used for TIP frame prediction processes available information for the TIP frame to determine a motion vector for a hole (i.e., an area on the TIP frame that does not coincide with a motion vector from either reference frame to the other). Existing hole filling approaches for TIP frame prediction are epoch-based, and as such utilize increasingly larger sets of data on an epoch basis relative to a location of a given hole. For example, the location of the hole within the TIP frame may correspond to epoch zero, the four non-diagonal spatial neighbors of the hole (i.e., in “north, south, east, and west” positions relative to the location of the hole) may correspond to epoch one, the four non-diagonal spatial neighbors of each of the epoch one neighbors may correspond to epoch two, and so on. These existing hole filling approaches for TIP frame prediction operate one epoch at a time, but have unbounded execution times and unlimited reach, generally in the reverse-of-the-scan direction, ensuring that appropriate information from any epoch can be considered.

While these approaches may conceptually enable highly accurate motion vector derivations for filling in any holes within a TIP frame, they also require significant computing resources, making them infeasible solutions for certain approaches, such as where TIP frame prediction is performed using a hardware coder (e.g., a hardware encoder or decoder). In particular, because these hole filling approaches operate on an epoch-basis and have unlimited reach, they may in some cases be used to determine a motion vector for a hole in one corner of the TIP frame using a motion vector from an opposite corner of the TIP frame. However, because hardware coders process temporally adjacent motion vectors in a streaming fashion, meaning that the motion vectors for locations which have not yet been loaded cannot be utilized, a hardware coder will be unable to begin performing this hole filling until the information for all epochs becomes available. Relatedly, because these hole filling approaches operate on an epoch-basis with unlimited reach, they have unbounded execution time. This is problematic for hardware coders as they typically must guarantee a certain performance which cannot be guaranteed when execution time is unbounded.

Moreover, because these hole filling approaches operate on an epoch-basis with unlimited reach, motion vectors pointing between a coded picture and a TIP frame are able to have unrestricted magnitudes. This is problematic for hardware coders as, given the streaming fashion with which temporally adjacent motion vectors are processed, the temporally adjacent motion field from which motion vectors are derived is processed superblock-by-superblock. As such, a motion vector determined using these hole filling approaches can potentially point to an area already evicted from a work buffer or cache of the hardware coder or to an area which has not yet been loaded by the hardware coder, thereby preventing the motion vector from being calculated or otherwise requiring areas not presently in the work buffer or cache to be added therein, thereby introducing latency and computational strain violating the specified performance requirements of the hardware coder. The use of an epoch-based approach for hole filling in TIP frame prediction is thus incompatible with conventional hardware coder design. Furthermore, given the above-stated hardware coder limitations related to the buffer eviction and loading of limited data sets for a TIP frame, motion vectors with unrestricted magnitudes present their own challenges incompatible with conventional hardware coder design, independent of associations with hole filling approaches for TIP frame prediction.

Implementations of this disclosure address problems such as these using novel approaches to motion vector magnitude restriction and hole filling for interpolated reference frame (e.g., TIP frame) prediction. In some implementations, the magnitude of a motion vector determined for a hole in a TIP frame is restricted such that the location to which it points within the TIP frame is within a same current superblock that the hole is located in or within a set of superblocks that includes the current superblock. For example, the motion vector may be restricted so that the interpolation of the inter prediction performed for the TIP frame only accesses pixels from the same current superblock in which the hole is located. In another example, the region of the TIP frame to which the motion vector is restricted may include a set of superblocks (e.g., ten, in which the current superblock is located in a central portion thereof). In some implementations, hole filling is performed for TIP frame prediction without the use of epochs for motion vector determination by leveraging a scan order processing of cell data within a current superblock. For example, cells within each row and column of the current superblock may be traversed to determine whether a motion vector is available through the typical TIP frame prediction motion vector derivation process. In the event the motion vector is available, it is retained as a current seed; otherwise, the location is identified as a hole and is filled with the current seed. The implementations of this disclosure accordingly enable significant improvements to TIP frame prediction allowing for its use in hardware coder use cases, without an epoch basis for performing hole filling against areas of a TIP frame and without allowing for the unbounded magnitude of determined or derived motion vectors.

While reference is made herein by example to superblocks, macroblocks, blocks, and the like, as are commonly used in video codecs such as VP9, AV1, and the currently in-development AV2, the implementations of this disclosure may be used with other video coding structures. In one particular but non-limiting example, the implementations of this disclosure may be used with CTUs, CUs, PUs, and the like, as are commonly used in video codecs such as H.265, referred to as High-Efficiency Video Coding, and H.266, referred to as Versatile Video Coding. Accordingly, references herein to particular video coding structures such as superblocks, macroblocks, blocks, and the like shall be regarded as expressions of non-limiting example video coding structures with which the implementations of this disclosure may be used. Moreover, while references are made throughout this disclosure to TIP frames and the prediction thereof, the implementations of this disclosure may alternatively use, operate, or otherwise be performed for other types of generated reference frames. As such, references to TIP frames throughout this disclosure may be substituted by “generated reference frame” or other types of generated reference frames.

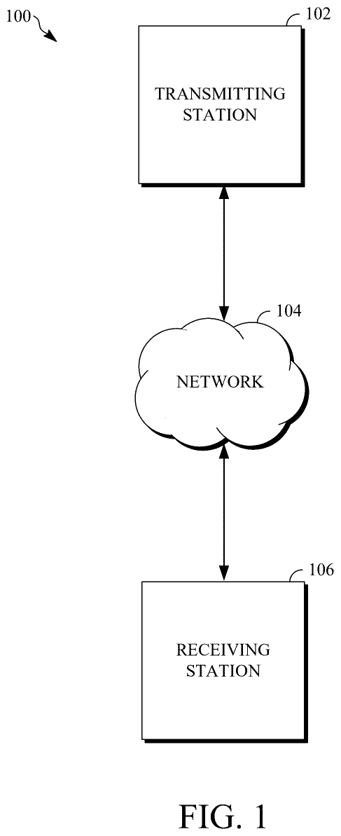

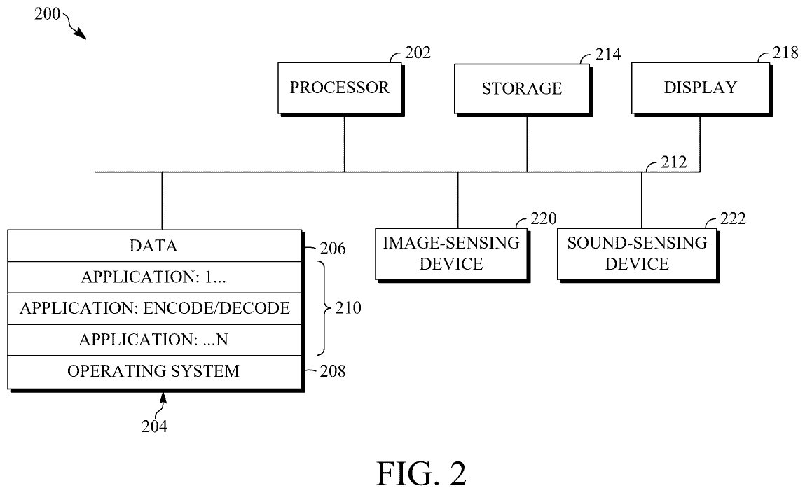

Further details of techniques for motion vector magnitude restriction and hole filling for TIP frame prediction are described herein with initial reference to a system in which such techniques can be implemented. FIG. 1 is a schematic of an example of a video encoding and decoding system 100. A transmitting station 102 can be, for example, a computer having an internal configuration of hardware such as that described in FIG. 2. However, other implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used (e.g., a Hypertext Transfer Protocol-based (HTTP-based) video streaming protocol).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

In some implementations, the video encoding and decoding system 100 may instead be used to encode and decode data other than video data. For example, the video encoding and decoding system 100 can be used to process image data. The image data may include a block of data from an image. In such an implementation, the transmitting station 102 may be used to encode the image data and the receiving station 106 may be used to decode the image data.

Alternatively, the receiving station 106 can represent a computing device that stores the encoded image data for later use, such as after receiving the encoded or pre-encoded image data from the transmitting station 102. As a further alternative, the transmitting station 102 can represent a computing device that decodes the image data, such as prior to transmitting the decoded image data to the receiving station 106 for display.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read only memory (ROM) device or a random access memory (RAM) device in an implementation. However, other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include encoding and/or decoding software that performs, amongst other things, motion vector magnitude restriction and hole filling for TIP frame prediction as described herein.

The computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into one unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200.

Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

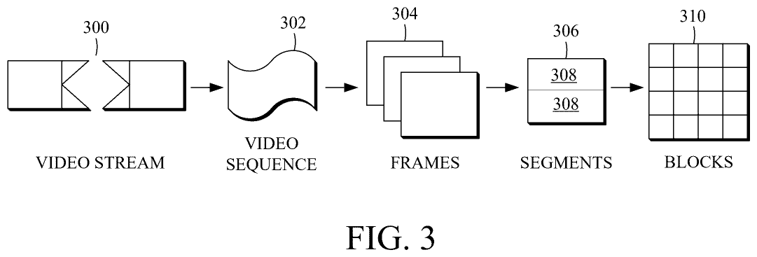

FIG. 3 is a diagram of an example of a video stream 300 to be encoded and decoded. The video stream 300 includes a video sequence 302. At the next level, the video sequence 302 includes a number of adjacent video frames 304. While three frames are depicted as the adjacent frames 304, the video sequence 302 can include any number of adjacent frames 304. The adjacent frames 304 can then be further subdivided into individual video frames, for example, a frame 306.

At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, N×M pixels in the frame 306, in which N and M may refer to the same integer value or to different integer values. The blocks 310 can also be arranged to include data from one or more segments 308 of pixel data. The blocks 310 can be of any suitable size, such as 4×4 pixels, 8×8 pixels, 16×8 pixels, 8×16 pixels, 16×16 pixels, or larger up to a maximum block size, which may be 128×128 pixels or another N×M pixels size.

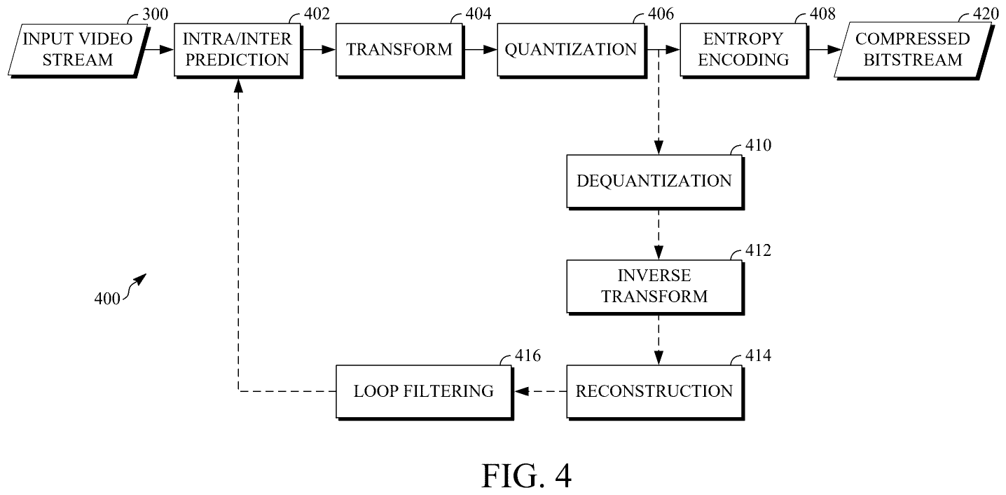

FIG. 4 is a block diagram of an example of an encoder 400. The encoder 400 can be implemented, as described above, in the transmitting station 102, such as by providing a computer software program stored in memory, for example, the memory 204. The computer software program can include machine instructions that, when executed by a processor such as the processor 202, cause the transmitting station 102 to encode video data in the manner described in FIG. 4. The encoder 400 can also be implemented as specialized hardware included in, for example, the transmitting station 102. In some implementations, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

In some cases, the functions performed by the encoder 400 may occur after a filtering of the video stream 300. That is, the video stream 300 may undergo pre-processing according to one or more implementations of this disclosure prior to the encoder 400 receiving the video stream 300. Alternatively, the encoder 400 may itself perform such pre-processing against the video stream 300 prior to proceeding to perform the functions described with respect to FIG. 4, such as prior to the processing of the video stream 300 at the intra/inter prediction stage 402.

When the video stream 300 is presented for encoding after the pre-processing is performed, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated.

The quantized transform coefficients are then entropy encoded by the entropy encoding stage 408. The entropy-encoded coefficients, together with other information used to decode the block (which may include, for example, syntax elements such as used to indicate the type of prediction used, transform type, motion vectors, a quantizer value, or the like), are then output to the compressed bitstream 420. The compressed bitstream 420 can be formatted using various techniques, such as variable length coding or arithmetic coding. The compressed bitstream 420 can also be referred to as an encoded video stream or encoded video bitstream, and the terms will be used interchangeably herein.

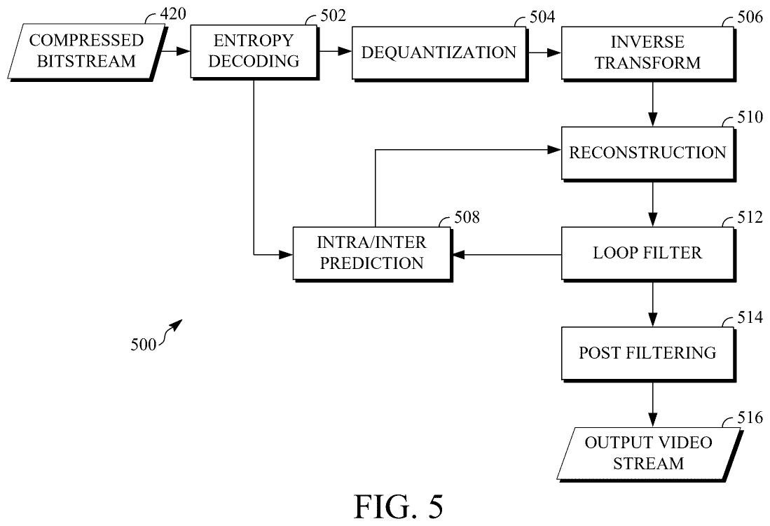

The reconstruction path (shown by the dotted connection lines) can be used to ensure that the encoder 400 and a decoder 500 (described below with respect to FIG. 5) use the same reference frames to decode the compressed bitstream 420. The reconstruction path performs functions that are similar to functions that take place during the decoding process (described below with respect to FIG. 5), including dequantizing the quantized transform coefficients at the dequantization stage 410 and inverse transforming the dequantized transform coefficients at the inverse transform stage 412 to produce a derivative residual block (also called a derivative residual).

At the reconstruction stage 414, the prediction block that was predicted at the intra/inter prediction stage 402 can be added to the derivative residual to create a reconstructed block. The loop filtering stage 416 can apply an in-loop filter or other filter to the reconstructed block to reduce distortion such as blocking artifacts. Examples of filters which may be applied at the loop filtering stage 416 include, without limitation, a deblocking filter, a directional enhancement filter, and a loop restoration filter.

Other variations of the encoder 400 can be used to encode the compressed bitstream 420. In some implementations, a non-transform based encoder can quantize the residual signal directly without the transform stage 404 for certain blocks or frames. In some implementations, an encoder can have the quantization stage 406 and the dequantization stage 410 combined in a common stage.

FIG. 5 is a block diagram of an example of a decoder 500. The decoder 500 can be implemented in the receiving station 106, for example, by providing a computer software program stored in the memory 204. The computer software program can include machine instructions that, when executed by a processor such as the processor 202, cause the receiving station 106 to decode video data in the manner described in FIG. 5. The decoder 500 can also be implemented in hardware included in, for example, the transmitting station 102 or the receiving station 106. In some implementations, the decoder 500 is a hardware decoder.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a post filter stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400 (e.g., at the intra/inter prediction stage 402).

At the reconstruction stage 510, the prediction block can be added to the derivative residual to create a reconstructed block. The loop filtering stage 512 can be applied to the reconstructed block to reduce blocking artifacts. Examples of filters which may be applied at the loop filtering stage 512 include, without limitation, a deblocking filter, a directional enhancement filter, and a loop restoration filter. Other filtering can be applied to the reconstructed block. In this example, the post filter stage 514 is applied to the reconstructed block to reduce blocking distortion, and the result is output as the output video stream 516. The output video stream 516 can also be referred to as a decoded video stream, and the terms will be used interchangeably herein.

Other variations of the decoder 500 can be used to decode the compressed bitstream 420. In some implementations, the decoder 500 can produce the output video stream 516 without the post filter stage 514 or otherwise omit the post filter stage 514.

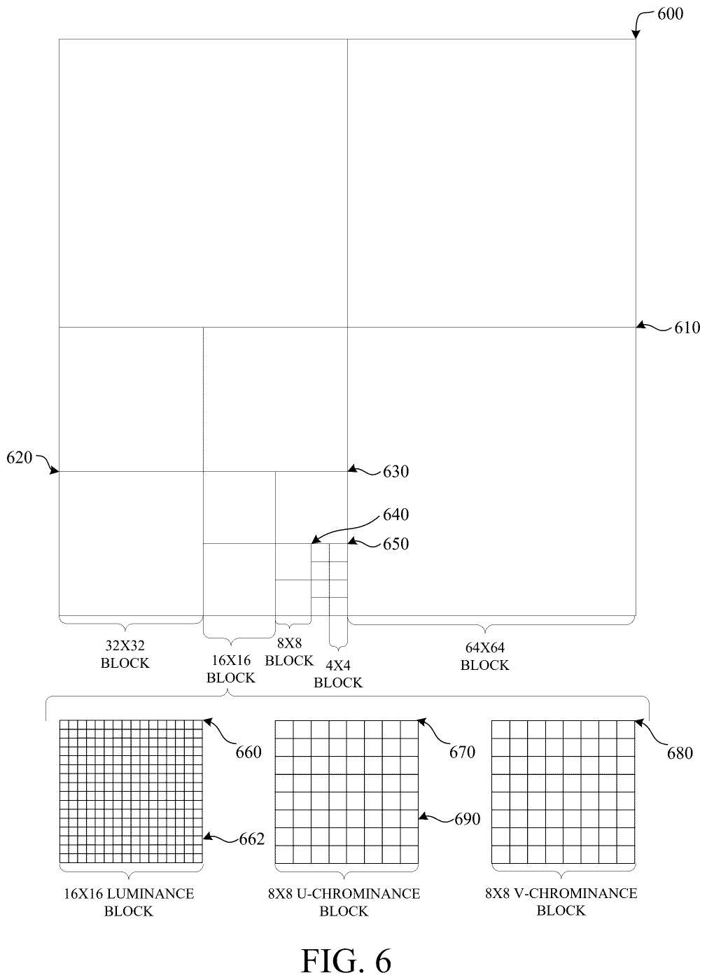

FIG. 6 is an illustration of examples of portions of a video frame 600, which may, for example, be the frame 306 shown in FIG. 3. The video frame 600 includes a number of 64×64 blocks 610, such as four 64×64 blocks 610 in two rows and two columns in a matrix or Cartesian plane, as shown. Each 64×64 block 610 may include up to four 32×32 blocks 620. Each 32×32 block 620 may include up to four 16×16 blocks 630. Each 16×16 block 630 may include up to four 8×8 blocks 640. Each 8×8 block 640 may include up to four 4×4 blocks 950. Each 4×4 block 950 may include 16 pixels, which may be represented in four rows and four columns in each respective block in the Cartesian plane or matrix. In some implementations, the video frame 600 may include blocks larger than 64×64 and/or smaller than 4×4. Subject to features within the video frame 600 and/or other criteria, the video frame 600 may be partitioned into various block arrangements.

The pixels may include information representing an image captured in the video frame 600, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used, wherein N and M are different numbers. For example, 32×64 blocks, 64×32 blocks, 16×32 blocks, 32×16 blocks, or any other size blocks may be used. In some implementations, N×2N blocks, 2N×N blocks, or a combination thereof, may be used.

In some implementations, coding the video frame 600 may include ordered block-level coding. Ordered block-level coding may include coding blocks of the video frame 600 in an order, such as raster-scan order, wherein blocks may be identified and processed starting with a block in the upper left corner of the video frame 600, or portion of the video frame 600, and proceeding along rows from left to right and from the top row to the bottom row, identifying each block in turn for processing. For example, the 64×64 block in the top row and left column of the video frame 600 may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block of the video frame 600 may include using quad-tree coding, which may include coding smaller block units within a block in raster-scan order. For example, the 64×64 block shown in the bottom left corner of the portion of the video frame 600 may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, coding the video frame 600 may include encoding the information included in the original version of the image or video frame by, for example, omitting some of the information from that original version of the image or video frame from a corresponding encoded image or encoded video frame. For example, the coding may include reducing spectral redundancy, reducing spatial redundancy, or a combination thereof. Reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of the video frame 600, and using a relatively small amount of information to represent each corresponding chrominance component for the portion of the video frame 600. For example, a portion of the video frame 600 may be represented by a high-resolution luminance component, which may include a 16×16 block of pixels, and by two lower resolution chrominance components, each of which represents the portion of the image as an 8×8 block of pixels. A pixel may indicate a value, for example, a value in the range from 0 to 255, and may be stored or transmitted using, for example, eight bits. Although this disclosure is described in reference to the YUV color model, another color model may be used. Reducing spatial redundancy may include transforming a block into the frequency domain using, for example, a discrete cosine transform. For example, a unit of an encoder may perform a discrete cosine transform using transform coefficient values based on spatial frequency.

Although described herein with reference to matrix or Cartesian representation of the video frame 600 for clarity, the video frame 600 may be stored, transmitted, processed, or a combination thereof, in a data structure such that pixel values may be efficiently represented for the video frame 600. For example, the video frame 600 may be stored, transmitted, processed, or any combination thereof, in a two-dimensional data structure such as a matrix as shown, or in a one-dimensional data structure, such as a vector array. Furthermore, although described herein as showing a chrominance subsampled image where U and V have half the resolution of Y, the video frame 600 may have different configurations for the color channels thereof. For example, referring still to the YUV color space, full resolution may be used for all color channels of the video frame 600. In another example, a color space other than the YUV color space may be used to represent the resolution of color channels of the video frame 600.

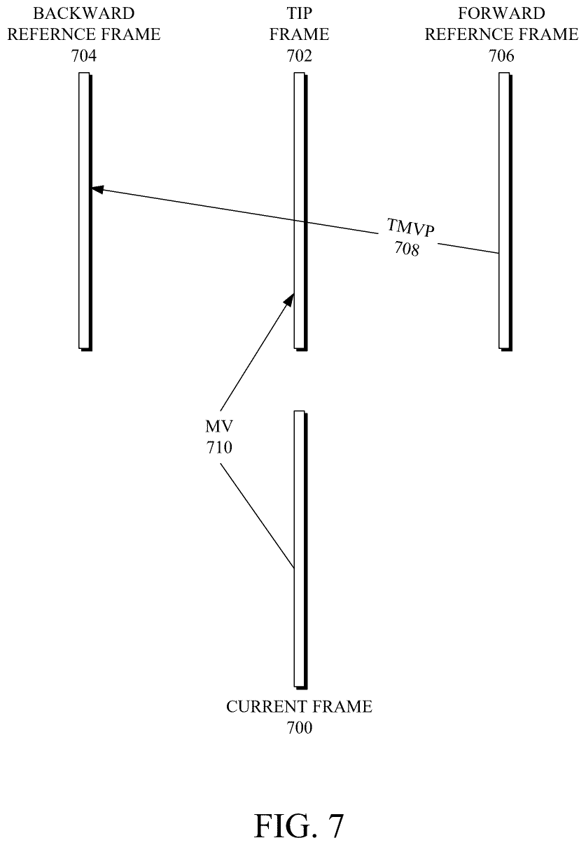

FIG. 7 is an illustration of frames used in connection with TIP frame prediction. A current frame 700 represents a frame under prediction using the TIP mode described herein, for example, during encoding (e.g., at the intra/inter prediction stage 402) or decoding (e.g., at the intra/inter prediction stage 510). A TIP frame 702 is generated on a streaming basis (i.e., portion by portion) using a motion field derived based on a backward reference frame 704 and a forward reference frame 706 of the current frame 700. For example, where the current frame 700 is denoted as Fᵢ, the backward reference frame 704 can be denoted at Fᵢ₋₁, and the forward reference frame 706 can be denoted as Fᵢ₊₁.

Generally, the backward reference frame 704 and the forward reference frame 706 will be the same distance apart from the current frame 700 in a display order of the video sequence that includes them. However, in some implementations, the backward reference frame 704 and the forward reference frame 706 may be different distances apart from the current frame 800 in the display order. A temporal motion vector predictor 708 represents a motion vector predictor pointing from the backward reference frame 704 to the forward reference frame 706. A motion vector 710 pointing from the current frame 700 to the TIP frame 702 represents a motion vector which may be used with the TIP frame 702 to predict the motion within one or more blocks of the current frame 700.

In particular, the reference frames 704 and 706 have already been coded by the time they are identified for use as reference frames for the current frame 700. As such, motion vectors of the reference frames 704 and 706 are already known and available, from the earlier coding of the reference frames 704 and 706. Thus, once the reference frames 704 and 706 are identified, a motion field is determined for the current frame 700 using the motion vectors of the reference frames 704 and 706. In particular, the motion field includes motion field motion vectors each pointing to one of the forward reference frame 706 or the backward reference frame 704. The motion field effectively represents how the motion field motion vectors can be projected to determine motion vectors for the current frame 700, since the current frame 700 is in between the backward reference frame 704 and the forward reference frame 706. In some cases, a compound motion vector derivation approach may be used.

The motion field determined for the current frame 700 using the motion vectors of the backward reference frame 704 and the forward reference frame 706 has a same size as the current frame 700. The motion field for the current frame 700 may be separately determined at each of an encoder and a decoder to reduce bitstream size otherwise used for signaling the motion field. Once the motion field has been determined, the motion field motion vectors of the motion field can be stored for later use. For example, the motion field motion vectors may be stored in a memory buffer or cache.

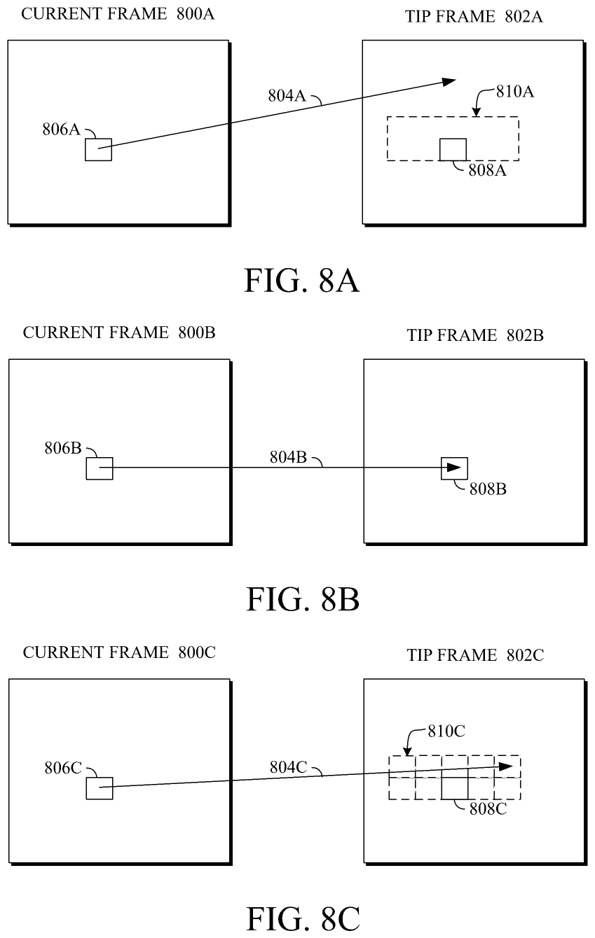

FIGS. 8A-C are illustrations of unrestricted and restricted motion vectors for TIP frame prediction. Referring first to FIG. 8A, a current frame 800A and a TIP frame 802A (e.g., the current frame 700 and the TIP frame 702 shown in FIG. 7) are shown. The current frame 800A and the TIP frame 802A are processed by a software coder capable of generating the entire TIP frame 802A or otherwise storing multiple portions of the TIP frame 802A concurrently (e.g., in a memory buffer or cache), without limitations imposed upon hardware coders. Thus, motion of the current frame 800A may be referenced anywhere in the TIP frame 802A using unrestricted motion vectors (i.e., motion vectors without a restricted magnitude) by the software coder generating portions of the TIP frame 802A on an as-needed basis. In particular, a motion vector 804A (e.g., the motion vector 710 shown in FIG. 7) may point from a current block 806A (e.g., a superblock) at a location (X, Y) through (X+M, Y+N) within the current frame 800A, in which M and N are integers and may or may not be the same number, to an area within the TIP frame 802A other than a same block 808A (e.g., a superblock) at the location (X, Y) through (X+M, Y+N) within the TIP frame 802A. The motion vector 804A is thus unrestricted as its magnitude enables it to point outside the same block 808A as well as a surrounding area 810A representing a set of blocks above, to the left, and to the right of the current block 808A which would be accessible within a working buffer or cache of a hardware coder if the hardware coder were instead processing the current frame 800A and the TIP frame 802A.

Referring next to FIG. 8B, a current frame 800B and a TIP frame 802B (e.g., the current frame 700 and the TIP frame 702) are shown. The current frame 800B and the TIP frame 802B are processed by a hardware coder configured according to the implementations of this disclosure to restrict motion vector magnitudes to within a same block. In particular, a motion vector 804B (e.g., the motion vector 710) may point from a current block 806B (e.g., a superblock) at a location (X, Y) through (X+M, Y+N) within the current frame 800B, in which M and N are integers and may or may not be the same number, to a same block 808B (e.g., a superblock) at the location (X, Y) through (X+M, Y+N) within the TIP frame 802B. The motion vector 804B is thus restricted as its magnitude prevents it from pointing outside the same block 808B. Because the motion vector 804B is restricted to pointing within the same block 808B, information already present within the working buffer or cache of the hardware coder can be accessed and used for the inter prediction of the current block 806B.

Thus, in the approach shown and described with respect to FIG. 8B, the motion vector 804B is restricted so that the interpolation of the inter prediction for the current block 806B only accesses pixels within the same block 808B. As such, the motion vector 804B is restricted such that the outline of the location it points to resides completely within the same block 808B. Any fractional portion of the motion vector 804B is accordingly omitted where the outline of the location the motion vector 804B points to resides close to the edge of the same block 808B on any side thereof. For example, where the left or top edge of the outline is closer than N (e.g., 3) pixels from the left or top respective edge of the same block 808B, the fractional portion may be omitted. In another example, where the bottom or right edge of the outline is closer than N (e.g., 4) pixels from the bottom or right respective edge of the same block 808, the fractional portion may be omitted.

Referring next to FIG. 8C, a current frame 800C and a TIP frame 802C (e.g., the current frame 700 and the TIP frame 702) are shown. The current frame 800C and the TIP frame 802C are processed by a hardware coder configured according to the implementations of this disclosure to restrict motion vector magnitudes to within a same block or a set of blocks that includes the same block. In particular, a motion vector 804C (e.g., the motion vector 710) may point from a current block 806C (e.g., a superblock) at a location (X, Y) through (X+M, Y+N) within the current frame 800C, in which M and N are integers and may or may not be the same number, to a location within the TIP frame 802 that corresponds to a set of blocks 810C (e.g., superblocks) that surround a same block 808C within at the location (X, Y) through (X+M, Y+N) within the TIP frame 802C. The motion vector 804C is restricted as its magnitude prevents it from pointing outside the set of blocks 810C that includes the same block 808C. Thus, the approach shown and described with respect to FIG. 8C incorporates the approach shown and described with respect to FIG. 8B but extends it to allow the motion vector 804C to have a magnitude such that it points either within the same block 808C or within the set of blocks 810C.

The set of blocks 810C refers to an area of the TIP frame 802C which has been processed by the hardware coder and thus which is available in the working buffer or cache of the hardware coder for use in performing inter prediction against the current block 806C using the TIP frame 802C. In the example shown, the set of blocks 808C includes two rows of blocks (e.g., superblocks) of size M×N, in which M and N are both integers of the same or a different value, in which the same block 808C is located in the middle of the bottom row. The seven blocks located before the same block 808C within the set of blocks 810C, according to a raster order, are recently coded blocks, while the two blocks located after the same block 808C within the set of blocks 810C, according to the raster order, correspond to a lookahead window of the hardware coder. In other examples, the set of blocks may include a different total number of blocks, including a different number of blocks before and/or after the same block 808C.

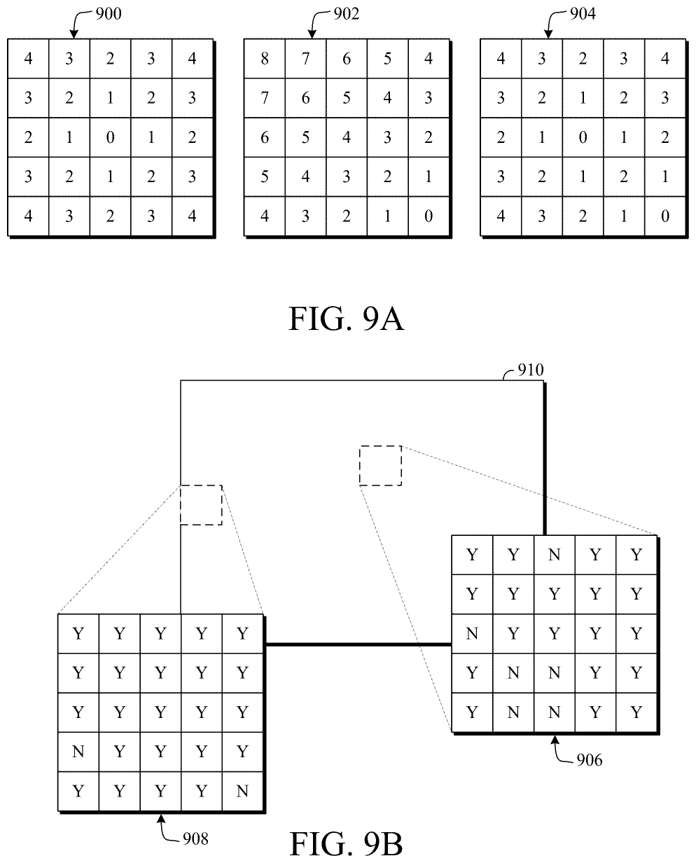

FIGS. 9A-B are illustrations of motion vector hole filling for TIP frame prediction. Referring first to FIG. 9A, example scenarios of an epoch-based approach for motion vector hole filling, represented by areas 900, 902, and 904 are shown. The areas 900, 902, and 904 each correspond to a portion of a TIP frame (e.g., the TIP frame 702 shown in FIG. 7), for example, one or more blocks (e.g., superblocks) thereof. The areas 900, 902, and 904 each depict a hole, that is, an area which does not coincide with any motion vectors, for example, because motion was not determined at that area between the reference frames used to produce the TIP frame (e.g., the backward and forward reference frames 704 and 706 shown in FIG. 7). In each of the areas 900, 902, and 904, a 0 value represents a seed (i.e., a location at which the hole filling process begins) and each other number value indicates the epoch in which a motion vector associated with a location of that number value (e.g., a superblock) can be determined for filling those portions of the hole. Thus, motion vectors associated with areas numbered “1” will be determined before motion vectors associated with areas numbered “2,” motion vectors associated with areas numbered “2” will be determined before motion vectors associated with areas numbered “3,” and so on.

The areas 900, 902, and 904 illustrate different potential hole locations and thus the orders in which various motion vectors may be considered. However, as described above, they also illustrate issues with hole filling approaches that limit or otherwise prevent their use in a hardware coder use case. For example, the area 900 shows a hole with a seed in a center thereof, and motion vectors corresponding to increasing epochs expanding outwardly therefrom. In such a case, since the hole filling algorithm effectively has unlimited reach, the epoch processing continues until all numbers for the area 900 are available, which overburdens the limited working buffer and cache size of the hardware coder. In another example, the area 902 shows a hole having a seed at a bottom right corner thereof, and motion vectors corresponding to epochs up to epoch 8. In such a case, the seed in the bottom right corner may thus have reach to a portion of a hole in the top left of the area 902, which may no longer be present within a working buffer or cache of the hardware coder. In yet another example, the area 804 shows two seeds, one in a center thereof and another in a bottom right corner thereof. In such a case, the epoch-based processing must accommodate both seeds, increasing the burden on the hardware coder.

Referring next to FIG. 9B, a hardware coder-friendly hole filling approach according to the implementations of this disclosure is illustrated using an area 906 and an area 908, each corresponding to a different portion of a TIP frame 910 (e.g., the TIP frame 702). This approach traverses rows and columns of the areas 906 and 908 to apply a temporal motion vector predictor recently evaluated within a neighboring cell to fill in an identified hole. In this way, this approach avoids the use of epochs and thus prevents unbounded execution time and unlimited reach issues caused by the use of epochs.

For each M×N (e.g., 128×8) row of a block (e.g., a superblock) of an area (i.e., all or a portion of the block, the portion having a square, rectangular, cross, or other shape), in which M and N are integers of the same or a different value, each N×N (e.g., 8×8) cell is evaluated along the row in a direction (e.g., from left to right). Where a motion vector is available (e.g., derivable via temporal motion vector predictor derivation) for the N×N cell through temporal motion vector predictor derivation, that motion vector is identified as a current seed. Where such a motion vector is not available (i.e., derivable) for the N×N cell, the N×N cell is identified as a hole and is filled in with the current seed. Next, for each N×M column of the block of the area, each N×N cell is evaluated along the column in a direction (e.g., from top to bottom). Where a motion vector is available for the N×N cell (e.g., derivable via temporal motion vector predictor derivation or provided by a hole being filled in when the rows of the block were traversed), that motion vector is identified as a current seed. Where such a motion vector is not available (i.e., derivable or provided by a prior hole filling) for the N×N cell, the N×N cell is identified as a hole and is filled in with the current seed.

In some cases, a hole may remain unfilled even after the above-described row and column evaluations are performed. For example, holes may remain within a block of the area 906 that is not located on an edge (e.g., a left side) of the TIP frame. In such a case, a hole may be filled with a motion vector determined based on an average of motion vectors derived or otherwise used via the row and column evaluations. For example, the motion vectors evaluated for the rows of the block may be averaged to produce a horizontal motion vector component value and the motion vectors for the columns of the block may be averaged to produce a vertical motion vector component value. The horizontal and vertical motion vector component values may thus be represented as an average motion vector for the block and used to fill in one or more holes remaining following the row and column evaluations.

To illustrate, the areas 906 and 908 are depicted by example as including five rows and five columns of N×N cells, in which each cell is marked with either a “Y” to indicate an available (e.g., derivable) motion vector for the cell or an “N” to indicate that there is no available motion vector for the cell. Referring first to the area 906, the top-left-most cell is evaluated first to determine that a motion vector is available, and that motion vector is temporarily stored as the current seed. The cell immediately to the right thereof is evaluated next to determine that a motion vector is available for it, as well. Because there is a motion vector available for that second cell, the motion vector available for the second cell replaces the previously stored motion vector as the current seed. The third cell in the row is then evaluated to determine that a motion vector is not available for it. Accordingly, the current seed, i.e., the motion vector from the second cell in the row, is used as the motion vector for that third cell.

Skipping down to the fourth row of the area 906, the motion vector of the first cell is available and thus identified as the current seed. That motion vector, as the current seed, is then used to fill in the hole in the second cell of that fourth row, for which a motion vector was not available. However, because the current seed has been used, the third cell in that fourth row, for which no motion vector is available, remains unfilled during the row evaluations. When the area 906 is next evaluated on a column basis, the motion vector available to the third cell of the third row is identified as the current seed and used to fill in the hole in the third cell of the fourth row. However, because the current seed has been used, the third cell in the third column (i.e., the fifth row) remains unfilled. The above-described averaging scheme may accordingly be used to determine a motion vector to use to fill in that remaining hole.

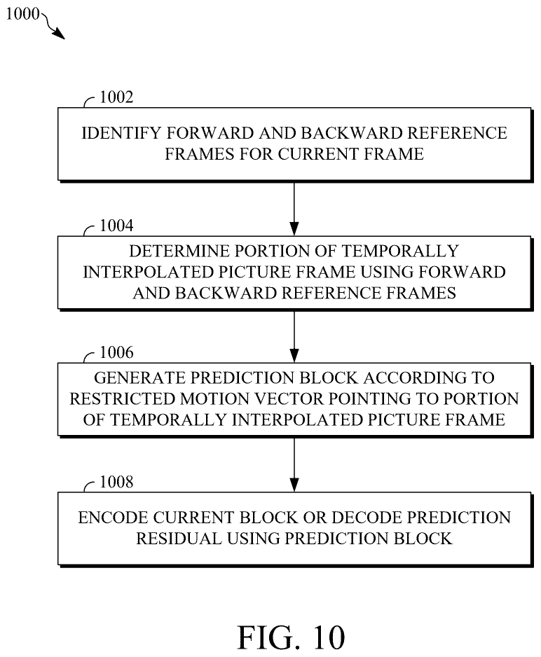

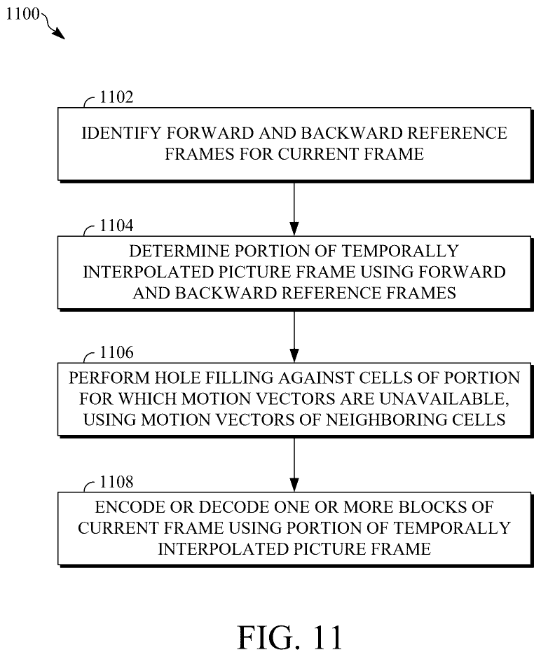

Further details of techniques for motion vector magnitude restriction and hole filling for TIP frame prediction are now described. FIG. 10 is a flowchart diagram of an example of a technique 1000 for motion vector magnitude restriction for TIP frame prediction. FIG. 11 is a flowchart diagram of an example of a technique 1100 for motion vector hole filling for TIP frame prediction. The technique 1000 and the technique 1100 may each, for example, be wholly or partially performed at a prediction stage of an encoder used to encode a video stream (e.g., the intra/inter prediction stage 402) or at a prediction stage of a decoder used to decode a bitstream (e.g., the intra/inter prediction stage 508).

The technique 1000 and/or the technique 1100 can be implemented, for example, as a software program that may be executed by computing devices such as the transmitting station 102 or the receiving station 106. For example, the software program can include machine-readable instructions that may be stored in a memory such as the memory 204 or the secondary storage 214, and that, when executed by a processor, such as the processor 202, may cause the computing device to perform the technique 1000 and/or the technique 1100. The technique 1000 and/or the technique 1100 can be implemented using specialized hardware or firmware. For example, a hardware component, such as a hardware coder, may be configured to perform the technique 1000 and/or the technique 1100. As explained above, some computing devices may have multiple memories or processors, and the operations described in the technique 1000 and/or the technique 1100 can be distributed using multiple processors, memories, or both. For simplicity of explanation, the technique 1000 and the technique 1100 are each depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

Referring first to FIG. 10, the technique 1000 for motion vector magnitude restriction for TIP frame prediction is shown. At 1002, forward and backward reference frames are identified for a current frame to encode or decode. The forward and backward reference frames are previously coded frames that are each some distance apart from the current frame in a display order of a video sequence, in which the backward reference frame occurs prior to the current frame in that display order and the forward reference frame occurs after the current frame in that display order. For example, the forward and backward reference frames may each be a same distance (measured in terms of numbers of frames between them individually and the current frame) to the current frame in the display order.

At 1004, a portion of a TIP frame is determined using the forward and backward reference frames. The portion of the TIP frame may correspond to an area of the current frame which includes a set of N (e.g., 10) blocks, in which the set of blocks includes a current block of the current frame, a number of blocks (e.g., 7) which precede the current block in a scan (e.g., raster) order (e.g., above and left of the current block), and a number of blocks which follow the current block in the scan order (e.g., right of the current block). In particular, the portion of the TIP frame corresponds to a portion that is presently within a working buffer or cache of a hardware coder performing the technique 1000.

At 1006, a prediction block is generated according to a restricted motion vector pointing to the portion of the TIP frame. In particular, the prediction block is generated by predicting the current block of the current frame according to a motion vector restricted to one of a same block located within the portion of the TIP frame or a set of blocks including the same block and located within the portion of the TIP frame, in which a location of the same block within the portion of the TIP frame corresponds to a location of the current block within the current frame. Implementations and examples of motion vector restriction used for generating the prediction block are described with respect to FIGS. 8B-C.

At 1008, depending on whether the technique 1000 is performed for encoding or decoding, the current block is encoded using the prediction block or a prediction residual associated with the current block is decoded using the prediction block. For example, encoding the current block using the prediction block can include generating a prediction residual for the current block using the prediction block, transforming the prediction residual from the spatial domain to the transform domain to produce transform coefficients, quantizing the transform coefficients to produce quantized transform coefficients, entropy coding the quantized transform coefficients to produce compressed current block data, and encoding the compressed current block data to the encoded bitstream. Data indicative of the restricted motion vector used for the prediction of the current block may be encoded in connection with the compressed current block data within the encoded bitstream. In another example, decoding a prediction residual associated with the current block using the prediction block can include adding the prediction block to a prediction residual of the current block decoded from the encoded bitstream. For example, data associated with the current block and signaled within the encoded bitstream may be entropy coded to produce quantized transform coefficients, dequantized to produce transform coefficients, and inverse transformed to produce the prediction residual, which may then be combined with the prediction generated for the current block to generate the reconstruction. The reconstruction of the current block may then be output within an output video stream. Outputting the reconstruction of the current block includes combining the reconstruction of the current block with reconstructions of other blocks of the current frame to produce a frame reconstruction for the current frame and then outputting the frame reconstruction. For example, the frame reconstruction may be output for display during playback of the output video stream at a computing device.

Referring next to FIG. 11, the technique 1100 for motion vector hole filling for TIP frame prediction is shown. At 1102, forward and backward reference frames are identified for a current frame to encode or decode. The forward and backward reference frames are previously coded frames that are each some distance apart from the current frame in a display order of a video sequence, in which the backward reference frame occurs prior to the current frame in that display order and the forward reference frame occurs after the current frame in that display order. For example, the forward and backward reference frames may each be a same distance (measured in terms of numbers of frames between them individually and the current frame) to the current frame in the display order.

At 1104, a portion of a TIP frame is determined using the forward and backward reference frames. The portion of the TIP frame may correspond to an area of the current frame which includes a set of N (e.g., 10) blocks, in which the set of blocks includes a current block of the current frame, a number of blocks (e.g., 7) which precede the current block in a scan (e.g., raster) order (e.g., above and left of the current block), and a number of blocks which follow the current block in the scan order (e.g., right of the current block). In particular, the portion of the TIP frame corresponds to a portion that is presently within a working buffer or cache of a hardware coder performing the technique 1100.

At 1106, hole filling is performed against cells of the portion of the TIP frame for which motion vectors are unavailable, using motion vectors of neighboring cells. A hole filling process is performed against the portion of the TIP frame by, for each row and column of the portion of the TIP frame, determining whether a motion vector is available for a current cell of the row or column, and, responsive to determining that a motion vector is unavailable for the current cell, using a motion vector a previous cell of the row or column as the motion vector for the current cell. Implementations and examples of motion vector hole filling used for performing the hole filling are described with respect to FIG. 9B.

At 1108, one or more blocks of the current frame are encoded or decoded using the portion of the TIP frame after the hole filling has been performed. For example, encoding a current block can include generating a prediction residual for the current block using a prediction block generated using a motion vector determined via the hole filling, transforming the prediction residual from the spatial domain to the transform domain to produce transform coefficients, quantizing the transform coefficients to produce quantized transform coefficients, entropy coding the quantized transform coefficients to produce compressed current block data, and encoding the compressed current block data to the encoded bitstream. Data indicative of the restricted motion vector used for the prediction of the current block may be encoded in connection with the compressed current block data within the encoded bitstream. In another example, decoding a current block can include adding a prediction block generated using a motion vector determined via the hole filling to a prediction residual of the current block decoded from the encoded bitstream. For example, data associated with the current block and signaled within the encoded bitstream may be entropy coded to produce quantized transform coefficients, dequantized to produce transform coefficients, and inverse transformed to produce the prediction residual, which may then be combined with the prediction generated for the current block to generate the reconstruction. The reconstruction of the current block may then be output within an output video stream. Outputting the reconstruction of the current block includes combining the reconstruction of the current block with reconstructions of other blocks of the current frame to produce a frame reconstruction for the current frame and then outputting the frame reconstruction. For example, the frame reconstruction may be output for display during playback of the output video stream at a computing device.

The implementations of this disclosure describe methods, systems, devices, apparatuses, and non-transitory computer readable media for motion vector magnitude restriction for generated reference frame prediction, as well as methods, systems, devices, apparatuses, and non-transitory computer readable media for hole filling for generated reference frame prediction.

In some implementations, a method for motion vector magnitude restriction for generated reference frame prediction comprises: identifying forward and backward reference frames for a current frame; determining a portion of a generated reference frame using the forward and backward reference frames; generating a prediction block by predicting a current block of the current frame according to a motion vector restricted to one of a same block located within the portion of the generated reference frame or a set of blocks including the same block and located within the portion of the generated reference frame, wherein a location of the same block within the portion of the generated reference frame corresponds to a location of the current block within the current frame; and decoding a prediction residual associated with the current block using the prediction block. In some implementations, a non-transitory computer readable medium has stored thereon an encoded bitstream configured for decoding by operations for motion vector magnitude restriction for generated reference frame prediction, the operations comprising: determining a portion of a generated reference frame using forward and backward reference frames for a current frame; generating a prediction block by predicting a current block of the current frame according to a motion vector restricted to one of a same block located within the portion of the generated reference frame or a set of blocks including the same block and located within the portion of the generated reference frame; and decoding a prediction residual associated with the current block using the prediction block. In some implementations, an apparatus for motion vector magnitude restriction for generated reference frame prediction comprises: a memory; and a processor configured to execute instructions stored in the memory to: generate a prediction block by predicting a current block of a current frame according to a motion vector restricted to one of a same block located within a portion of a generated reference frame or a set of blocks including the same block and located within the portion of the generated reference frame, wherein a location of the same block within the portion of the generated reference frame corresponds to a location of the current block within the current frame; and decode a prediction residual associated with the current block using the prediction block.

In some implementations of the method, the non-transitory computer readable medium, and/or the apparatus, the portion of the generated reference frame corresponds to an area of the current frame which includes the current block, one or more blocks which precede the current block in a scan order, and one or more blocks which follow the current block in the scan order.

In some implementations of the method, the non-transitory computer readable medium, and/or the apparatus, the area of the current frame is within a working buffer or cache of a hardware coder.

In some implementations of the method, the non-transitory computer readable medium, and/or the apparatus, the motion vector is restricted to the same block and an outline of a location to which the motion vector points resides completely within the same block.

In some implementations of the method, the non-transitory computer readable medium, and/or the apparatus, a fractional portion of the motion vector is omitted where the outline of the location resides within a threshold number of pixels of an edge of the same block.

In some implementations of the method, the non-transitory computer readable medium, and/or the apparatus, the motion vector is restricted to the set of blocks, the set of blocks includes multiple rows of blocks, and the same block is located in a bottom-most row of the multiple rows of blocks.

In some implementations of the method, the non-transitory computer readable medium, and/or the apparatus, one or more first blocks preceding the same block in a scan order are recently coded blocks and one or more second blocks following the same block in the scan order correspond to a lookahead window of a hardware coder.

In some implementations of the method, the non-transitory computer readable medium, and/or the apparatus, the generated reference frame is a temporally interpolated picture frame.

In some implementations of the method, the non-transitory computer readable medium, and/or the apparatus, a location of the same block within the portion of the generated reference frame corresponds to a location of the current block within the current frame.

In some implementations of the method, the non-transitory computer readable medium, and/or the apparatus, the portion of the generated reference frame is determined using forward and backward reference frames for the current frame.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same implementation unless described as such.

Implementations of the transmitting station 102 and/or the receiving station 106 (and the algorithms, methods, instructions, etc., stored thereon and/or executed thereby, including by the encoder 400 and the decoder 500, or another encoder or decoder as disclosed herein) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general purpose computer or general purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102 can encode content into an encoded video signal and transmit the encoded video signal to the communications device. In turn, the communications device can then decode the encoded video signal. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device.

Further, all or a portion of implementations of this disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described implementations and other aspects have been described in order to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method for motion vector magnitude restriction for generated reference frame prediction, the method comprising:
identifying forward and backward reference frames for a current frame;
determining a portion of a generated reference frame using the forward and backward reference frames;
generating a prediction block by predicting a current block of the current frame according to a motion vector restricted to one of a same block located within the portion of the generated reference frame or a set of blocks including the same block and located within the portion of the generated reference frame, wherein a location of the same block within the portion of the generated reference frame corresponds to a location of the current block within the current frame; and
decoding a prediction residual associated with the current block using the prediction block.

2. The method of claim 1, wherein the portion of the generated reference frame corresponds to an area of the current frame which includes the current block, one or more blocks which precede the current block in a scan order, and one or more blocks which follow the current block in the scan order.

3. The method of claim 2, wherein the area of the current frame is within a working buffer or cache of a hardware coder.

4. The method of claim 1, wherein the motion vector is restricted to the same block and an outline of a location to which the motion vector points resides completely within the same block.

5. The method of claim 4, wherein a fractional portion of the motion vector is omitted where the outline of the location resides within a threshold number of pixels of an edge of the same block.

6. The method of claim 1, wherein the motion vector is restricted to the set of blocks, the set of blocks includes multiple rows of blocks, and the same block is located in a bottom-most row of the multiple rows of blocks.

7. The method of claim 6, wherein one or more first blocks preceding the same block in a scan order are recently coded blocks and one or more second blocks following the same block in the scan order correspond to a lookahead window of a hardware coder.

8. The method of claim 1, wherein the generated reference frame is a temporally interpolated picture frame.

9. A non-transitory computer readable medium having stored thereon an encoded bitstream configured for decoding by operations for motion vector magnitude restriction for generated reference frame prediction, the operations comprising:
determining a portion of a generated reference frame using forward and backward reference frames for a current frame;
generating a prediction block by predicting a current block of the current frame according to a motion vector restricted to one of a same block located within the portion of the generated reference frame or a set of blocks including the same block and located within the portion of the generated reference frame; and
decoding a prediction residual associated with the current block using the prediction block.

10. The non-transitory computer readable medium of claim 9, wherein a location of the same block within the portion of the generated reference frame corresponds to a location of the current block within the current frame.

11. The non-transitory computer readable medium of claim 9, wherein the motion vector is restricted to the same block and an outline of a location to which the motion vector points resides completely within the same block.

12. The non-transitory computer readable medium of claim 11, wherein a fractional portion of the motion vector is omitted where the outline of the location resides within a threshold number of pixels of an edge of the same block.

13. The non-transitory computer readable medium of claim 9, wherein the motion vector is restricted to the set of blocks, the set of blocks includes multiple rows of blocks, and the same block is located in a bottom-most row of the multiple rows of blocks.

14. The non-transitory computer readable medium of claim 13, wherein one or more first blocks preceding the same block in a scan order are recently coded blocks and one or more second blocks following the same block in the scan order correspond to a lookahead window of a hardware coder.

15. An apparatus for motion vector magnitude restriction for generated reference frame prediction, the apparatus comprising:
a memory; and
a processor configured to execute instructions stored in the memory to:
generate a prediction block by predicting a current block of a current frame according to a motion vector restricted to one of a same block located within a portion of a generated reference frame or a set of blocks including the same block and located within the portion of the generated reference frame, wherein a location of the same block within the portion of the generated reference frame corresponds to a location of the current block within the current frame; and
decode a prediction residual associated with the current block using the prediction block.

16. The apparatus of claim 15, wherein the portion of the generated reference frame is determined using forward and backward reference frames for the current frame.

17. The apparatus of claim 15, wherein the motion vector is restricted to the same block and an outline of a location to which the motion vector points resides completely within the same block.

18. The apparatus of claim 17, wherein a fractional portion of the motion vector is omitted where the outline of the location resides within a threshold number of pixels of an edge of the same block.

19. The apparatus of claim 15, wherein the motion vector is restricted to the set of blocks, the set of blocks includes multiple rows of blocks, and the same block is located in a bottom-most row of the multiple rows of blocks.

20. The apparatus of claim 19, wherein one or more first blocks preceding the same block in a scan order are recently coded blocks and one or more second blocks following the same block in the scan order correspond to a lookahead window of a hardware coder.
